(19) United States
(12) Patent Application Publication
(10) Pub. No.: US 2018/0202420 A1
(43) Pub. Date: Jul. 19, 2018

(54) WEARABLE POWER SUPPLY DEVICE CAPABLE OF CAPTURING HUMAN MOTION

(71) Applicant: Chi Man WONG, Hong Kong (HK)

(72) Inventor: Chi Man WONG, Hong Kong (HK)

(21) Appl. No.: 15/415,814

(22) Filed: Jan. 25, 2017

(30) Foreign Application Priority Data
Jan. 16, 2017 (CN) 201710029183.3

(51) Int. Cl. F03G 7/08; H02J 7/00; H01R 24/60; F03G 5/06; H02K 7/18

(52) U.S. Cl. CPC F03G 7/08; H02J 7/0052; H01R 24/60; H01R 2107/00; F03G 5/06; H02K 7/1892; H02J 7/0063

(57) ABSTRACT

The present invention relates to a wearable power supply device capable of capturing human motion comprising a housing, a rotating shaft, a connection rod, a first swinging block, a second swinging block, a first coil, a second coil, a T-shaped transmission element and a pull rod. A first coil and a second coil is fixedly disposed inside the first cavity and the second cavity respectively. The rotating shaft is disposed off-center. The connection rod is fixedly connected to the first swinging block and the second swinging block. An end of the T-shaped transmission element is hinged to the separator plate, another end of the T-shaped transmission element is abut against the end of the rotating shaft within the second cavity. An end of the pull rod is hinged to the T-shaped transmission element, another end of the pull rod penetrates out from the housing. The structure of the device is sensible, simple, convenient and adapted for travelling, solving the problem of charging of portable devices effectively.

### BACKGROUND OF INVENTION

The present invention relates to the field of wearable devices, in particular to a wearable power supply device capable of capturing human motion.

In existing technology, wearable devices are portable devices that are directly worn on a user or integrated to the clothes or accessories of the user. With the development of smart portable devices such as smart phone, smart band or smart glasses, more and more portable devices are entering people's lives. While they bring convenience to the people, they also carry a problem that, hindered by the existing power supply technology, power stored within the batteries of portable devices are limited, so is unable to supply power for a long period of time. Finding sockets for charging portable devices is obviously annoying. While portable power supplies are able to temporarily solve the charging problem, they are in fact just bigger and heavier batteries. Therefore, power supply devices that can continuously generate power and are portable needs to be developed.

### SUMMARY OF INVENTION

The technical problem to be solved by the present invention is: to overcome the aforementioned problem, a wearable power supply device capable of capturing human motion is provided. The structure of the device is sensible, simple, convenient and adapted for travelling, solving the problem of charging of portable devices effectively.

The technical solution used in the present invention to solve the technical problem is: a wearable power supply device capable of capturing human motion comprising a housing, a rotating shaft, a connection rod, a first swinging block, a second swinging block, a first coil, a second coil, a T-shaped transmission element and a pull rod. The housing is divided into a first cavity and a second cavity by a separator plate. A first coil and a second coil is fixedly disposed inside the first cavity and the second cavity respectively.

The rotating shaft extends through separator plate transversely, and is disposed off-center of the separator plate. The connection rod is fixedly connected to an end of the rotating shaft within the first cavity. An end of the connection rod is fixedly connected to the first swinging block, another end of the connection rod is fixedly connected to the second swinging block, penetrating through the arc-shaped tunnel. A pair of springs are symmetrically disposed inside the arc-shaped tunnel at two sides of the connection rod.

The T-shaped transmission element is disposed within the second cavity. An end of the T-shaped transmission element is hinged to the separator plate, another end of the T-shaped transmission element is abut against the end of the rotating shaft within the second cavity. Magnets are further embedded at a surface of the T-shaped transmission element contacting the rotating shaft. An end of the pull rod is hinged to the T-shaped transmission element, another end of the pull rod penetrates out from the housing.

In an exemplary embodiment, the first swinging block and the second swinging block are fan-shaped structures made of magnets.

In an exemplary embodiment, multiple rollers are disposed on the first swinging block via a frame, each roller is separately rollably connected to the housing.

In an exemplary embodiment, the first swinging block and the second swinging block, along with the second coil and the first coil respectively, are symmetrically disposed relative to the separator plate.

In an exemplary embodiment, a charge and discharge control circuit board electrically connected to the second coil and the first coil, and a battery electrically connected to the charge and discharge control circuit board are disposed within the second cavity.

In an exemplary embodiment, a first fastening strap is disposed on the housing for wearing onto human body.

In an exemplary embodiment, a second fastening strap is disposed on the pull rod for wearing onto human body.

In an exemplary embodiment, a USB power output connector electrically connected to the charge and discharge control circuit board is disposed on the housing.

The advantage of the present invention is: the wearable power supply device capable of capturing human motion according to the present invention comprises a cylindrical housing, a rotating shaft, a pull rod, a first swinging block, a second swinging block, a first coil, a second coil, a T-shaped transmission element and a pull rod. The housing is fastened onto a side of a calf of a user through the first fastening strap, and the pull rod is fastened onto a side of a thigh of the user through the second fastening strap. The housing is divided into two cavities by the separator plate, the first coil and the second coil is disposed on the separator plate. The rotating shaft penetrates through the separator plate off-center of the separator plate, the first swinging block and the second swinging block symmetrical to the respective coils are disposed on the shaft through the connection rod. The device utilizes the kinetic energy generated from lateral motion of the human body to bring the swinging blocks to swing, the change in flux leads to power being generated in the coil. The rotating shaft setting in an off-center position facilitates swinging of the swinging blocks. Springs disposed at the separator plate provides damping effect, so is more comfortable when worn. Furthermore, magnets are disposed on the T-shaped transmission element hinged to the housing, when the human body is in vertical motion such as walking on stairs, bending of knee joint drives the pull rod and indirectly drives the rotating shaft to rotate, so power efficiency is increased. The present invention further comprises a charge and discharge control circuit board within the housing, storing the accumulated power in the battery, and outputs power through the USB power connector during use. The structure of the device is sensible, simple, convenient and adapted for travelling, solving the problem of charging of portable devices effectively.

### BRIEF DESCRIPTION OF DRAWINGS

The present invention is further explained below with the accompanying drawings and embodiments.

FIG. 1 is an overall structural schematic diagram of a wearable power supply device capable of capturing human motion according to the present invention.

FIG. 2 is a front view schematic diagram of a wearable power supply device capable of capturing human motion according to the present invention.

FIG. 3 is a rear view schematic diagram of a wearable power supply device capable of capturing human motion according to the present invention.

FIG. 4 is a schematic diagram of a T-shaped transmission element of a wearable power supply device capable of capturing human motion according to the present invention.

Legends in the drawings: 1 housing, 10 separator plate, 11 first cavity, 12 second cavity, 13 arc-shaped tunnel, 14 spring, 15 charge and discharge control circuit board, 16 battery, 17 first fastening strap, 18 USB power output connector, 2 rotating shaft, 3 connection rod, 4 first swinging block, 41 frame, 42 roller, 5 second swinging block, 6 first coil, 7 second coil, 8 T-shaped transmission element, 81 magnet, 9 pull rod, 91 second fastening strap.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

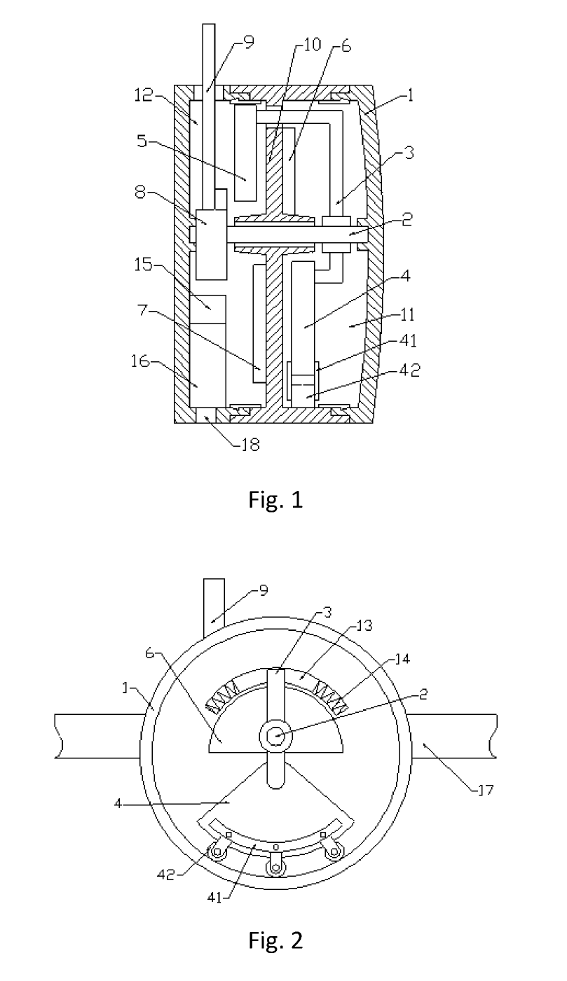

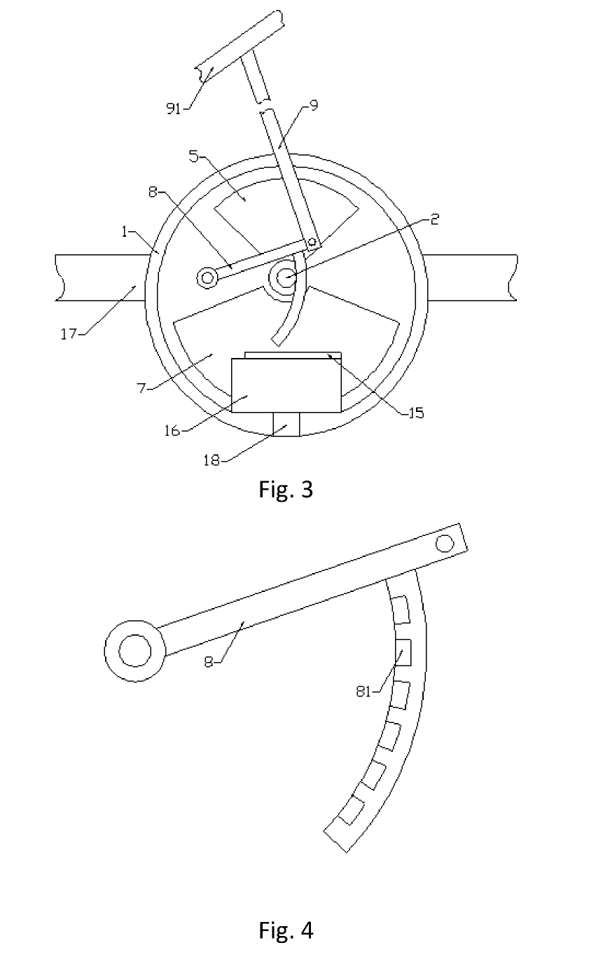

A wearable power supply device capable of capturing human motion as shown in FIGS. 1-4 comprises a housing 1, a rotating shaft 2, a connection rod 3, a first swinging block 4, a second swinging block 5, a first coil 6, a second coil 7, a T-shaped transmission element 8 and a pull rod 9. The housing 1 is divided into a first cavity 11 and a second cavity 12 by a separator plate 10. A first coil 6 and a second coil 7 is fixedly disposed inside the first cavity 11 and the second cavity 12 respectively.

The rotating shaft 2 extends through separator plate 10 transversely, and is disposed off-center of the separator plate 10. The connection rod 3 is fixedly connected to an end of the rotating shaft 2 within the first cavity 11. An end of the connection rod 3 is fixedly connected to the first swinging block 4, another end of the connection rod is fixedly connected to the second swinging block 5, penetrating through the arc-shaped tunnel 13. A pair of springs 14 are symmetrically disposed inside the arc-shaped tunnel 13 at two sides of the connection rod 3.

The T-shaped transmission element 8 is disposed within the second cavity. An end of the T-shaped transmission element 8 is hinged to the separator plate, another end of the T-shaped transmission element 8 is abut against the end of the rotating shaft 2 within the second cavity 12. Magnets 81 are further embedded at a surface of the T-shaped transmission element 8 contacting the rotating shaft 2. An end of the pull rod 9 is hinged to the T-shaped transmission element 8, another end of the pull rod 9 penetrates out from the housing 1.

The first swinging block 4 and the second swinging block 5 are fan-shaped structures made of magnet. Multiple rollers 42 are disposed on the first swinging block 4 via a frame 41, each roller 42 is separately rollably connected to the housing 1. The first swinging block 4 and the second swinging block 5, along with the second coil 7 and the first coil 6 respectively, are symmetrically disposed relative to the separator plate 10. A charge and discharge control circuit board 15 electrically connected to the second coil 7 and the first coil 6, and a battery electrically connected to the charge and discharge control circuit board 15, are disposed within the second cavity 12. A first fastening strap 17 is disposed on the housing 1 for wearing onto human body. A second fastening strap 91 is disposed on the pull rod 9 for wearing onto human body. A USB power output connector 18 electrically connected to the charge and discharge control circuit board 15 is disposed on the housing 1.

The wearable power supply device capable of capturing human motion according to the present invention comprises a cylindrical housing, a rotating shaft, a pull rod, a first swinging block, a second swinging block, a first coil, a second coil, a T-shaped transmission element and a pull rod. The housing is fastened onto a side of a calf of a user through the first fastening strap, and the pull rod is fastened onto a side of a thigh of the user through the second fastening strap. The housing is divided into two cavities by the separator plate, the first coil and the second coil is disposed on the separator plate. The rotating shaft penetrates through the separator plate off-center of the separator plate, the first swinging block and the second swinging block symmetrical to the respective coils are disposed on the shaft through the connection rod. The device utilizes the kinetic energy generated from lateral motion of the human body to bring the swinging blocks to swing, the change in flux leads to power being generated in the coil. The rotating shaft setting in an off-center position facilitates swinging of the swinging blocks. Springs disposed at the separator plate provides damping effect, so is more comfortable when worn. Furthermore, magnets are disposed on the T-shaped transmission element hinged to the housing, when the human body is in vertical motion such as walking on stairs, bending of knee joint drives the pull rod and indirectly drives the rotating shaft to rotate, so power efficiency is increased. The present invention further comprises a charge and discharge control circuit board within the housing, storing the accumulated power in the battery, and outputs power through the USB power connector during use. The structure of the device is sensible, simple, convenient and adapted for travelling, solving the problem of charging of portable devices effectively.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. A wearable power supply device capable of capturing human motion, comprising a housing, a rotating shaft, a connection rod, a first swinging block, a second swinging block, a first coil, a second coil, a T-shaped transmission element and a pull rod; the housing is divided into a first cavity and a second cavity by a separator plate; a first coil and a second coil is fixedly disposed inside the first cavity and the second cavity respectively;
the rotating shaft extends through separator plate transversely, and is disposed off-center of the separator plate; the connection rod is fixedly connected to an end of the rotating shaft within the first cavity; an end of the connection rod is fixedly connected to the first swinging block, another end of the connection rod is fixedly connected to the second swinging block, penetrating through the arc-shaped tunnel; a pair of springs are symmetrically disposed inside the arc-shaped tunnel at two sides of the connection rod;
the T-shaped transmission element is disposed within the second cavity; an end of the T-shaped transmission element is hinged to the separator plate, another end of the T-shaped transmission element is abut against the end of the rotating shaft within the second cavity; magnets are further embedded at a surface of the T-shaped transmission element contacting the rotating shaft; an end of the pull rod is hinged to the T-shaped transmission element, another end of the pull rod penetrates out from the housing.

2. The wearable power supply device capable of capturing human motion according to claim 1, characterized in that: the first swinging block and the second swinging block are fan-shaped structures made of magnets.

3. The wearable power supply device capable of capturing human motion according to claim 1, characterized in that: multiple rollers are disposed on the first swinging block via a frame, each roller is separately rollably connected to the housing.

4. The wearable power supply device capable of capturing human motion according to claim 1, characterized in that: the first swinging block and the second swinging block, along with the second coil and the first coil respectively, are symmetrically disposed relative to the separator plate.

5. The wearable power supply device capable of capturing human motion according to claim 1, characterized in that: a charge and discharge control circuit board electrically connected to the second coil and the first coil, and a battery electrically connected to the charge and discharge control circuit board are disposed within the second cavity.

6. The wearable power supply device capable of capturing human motion according to claim 1, characterized in that: a first fastening strap is disposed on the housing for wearing onto human body.

7. The wearable power supply device capable of capturing human motion according to claim 1, characterized in that: a second fastening strap is disposed on the pull rod for wearing onto human body.

8. The wearable power supply device capable of capturing human motion according to claim 1, characterized in that:

9. A USB power output connector electrically connected to the charge and discharge control circuit board is disposed on the housing.
